(19) United States
(12) Patent Application Publication
(10) Pub. No.: US 2004/0167283 A1
(43) Pub. Date: Aug. 26, 2004

(54) Linear polyphosphonates that exhibit an advantageous combination of properties, and methods related thereto

(76) Inventors: Michael Vinciguerra, Hampton, NH (US); Dieter Freitag, Chelmsford, MA (US)

Correspondence Address: Triton Systems, Inc. / IP Department, 200 Turnpike Rd., Chelmsford, MA, 01824, US

(21) Appl. No.: 10/374,155

(22) Filed: Feb. 24, 2003

(51) Int. Cl. C08L 73/00; C08G 67/00

(52) U.S. Cl. 525/132; 528/167; 524/534

(57) ABSTRACT

Disclosed are linear polyphosphonates produced by a transesterification process. These linear polyphosphonates exhibit a unique and advantageous combination of properties, such as outstanding fire resistance, unexpectedly high Tg's and good toughness at a low molecular weight. The favorable processing characteristics (such as low melt viscosity and excellent melt stability) of these linear polyphosphonates enable economic processing. Also disclosed are polymer compositions that comprise these linear polyphosphonates and at least one other polymer, wherein the resulting polymer compositions exhibit flame retardant properties. Further disclosed are articles of manufacture produced from these polymers, such as fibers, films, coated substrates, moldings, foams, fiber-reinforced articles, or any combination thereof, these articles may be coated with a moisture barrier to enhance their moisture resistance properties.

### TECHNICAL FIELD

The present invention relates generally to linear polyphosphonates, and more specifically to linear polyphosphonates produced via a transesterification process, polymer compositions comprising these linear polyphosphonates, and flame retardant coatings and articles produced therefrom.

### BACKGROUND

The production of linear, aromatic polyphosphonates by condensing aryl phosphonic acid dichlorides and aromatic diols in a solvent in the absence of a catalyst or in the presence of alkaline-earth metal halide catalysts is a known process and is described in several U.S. patents (see e.g., U.S. Pat. Nos. 2,534,252; 3,946,093; 3,919,363 and 6,288,210 B1). The polyphosphonates are isolated from the solutions by precipitation into methanol or by evaporation of the solvent. This synthetic route typically leads to relatively low molecular weight polymers that exhibit poor toughness and poor melt stability. In addition, the polymer chains have halogen end-groups that can readily react with moisture to form hydrolysis products. This ultimately leads to breakdown of the molecular weight of the polymer and degradation of its mechanical properties, particularly toughness. Due to the reactive end-groups, these materials do not form stable melts and thus make processing problematic. The high temperatures required for melt processing typically causes a reduction in their molecular weight with consequent loss of mechanical properties, particularly toughness.

The use of these materials as fire or flame retardant additives for various plastics has been described in several U.S. patents (see e.g., U.S. Pat. Nos. 3,719,727; 3,829,405; 3,830,771; 3,925,303 and 4,229,552). Such polyphosphonates are not useful as films or molded articles due to their low toughness, susceptibility to hydrolysis and melt instability. From an industrial viewpoint, such a synthetic method (condensing aryl phosphonic acid dichlorides and aromatic diols in a solvent) is undesirable because it requires the use of environmentally unfriendly solvents, such as methylene chloride, and leads to low molecular weight products with inferior properties that are sensitive to humidity, moisture, and high temperature. Further, the phosphonic acid dichlorides are hydrolytically sensitive and cannot be stored for long periods. Thus, these compounds require purification by distillation immediately prior to use. The overall effect of these issues and problems is the increase in the cost of production, which renders products that are not price or performance competitive in the marketplace.

Another synthetic approach that has shown promise in producing polyphosphonates has been the transesterification process. (see e.g., U.S. Pat. Nos. 2,682,522; 2,891,915 and 4,046,724). The transesterification process involves the reaction of a phosphonic acid diaryl ester, a bisphenol, and a basic catalyst carried out in the melt, usually in an autoclave. Transesterification is a chemical reaction that is an equilibrium between the starting materials (phosphonic acid diaryl ester and a bisphenol) and the products (polyphosphonate and phenol). The reaction is typically carried out at high temperature under reduced pressure. The by-product, phenol, is removed from the reaction by distillation; this helps shift the equilibrium toward polyphosphonate formation. One major problem with this process is that under the conditions of phenol removal, the phosphonic acid diaryl ester is also volatile and can co-distill with the phenol leading to stoichiometric imbalance and shifting of the equilibrium which leads to low molecular weight. This problem has been addressed by the placement of a distillation column in the process that allows for separation of the phenol from the phosphonic acid diaryl diester and condensation of the diester back into the reaction vessel. This approach has only achieved limited success because some of the phosphonic acid diaryl ester is still lost during the process, resulting in a stoichiometric imbalance and low molecular weight product. Thus, the reaction conditions (temperature, time, and pressure), stoichiometric balance of the starting materials, and the amount of catalyst are critical parameters necessary to synthesize polyphosphonates having an acceptable combination of high Tg, good processing characteristics (i.e., low melt viscosity and good melt stability), and good toughness.

The transesterification process, with respect to synthesis of linear polyphosphonates, has not been understood sufficiently until now, and the scientific and patent literature has shown that linear polyphosphonates of relatively low molecular weight having the desired combination of properties have not been prepared. In fact, much of the research and patents in this area have focused on the use of branching agents (tri and tetra functional phenols or phosphonic acid esters) (see e.g., U.S. Pat. Nos. 2,716,101; 3,326,852; 4,328,174; 4,331,614; 4,374,971; 4,415,719; 5,216,113; 5,334,692) or the use of copolymers (see e.g., U.S. Pat. Nos. 4,223,104; 4,322,520; 4,328,174; 4,401,802; 4,481,350; 4,508,890; 4,719,279; 4,762,905 and 4,782,123) as a means of increasing molecular weight and thereby toughness. These approaches have met with some degree of success, however, the combination of properties exhibited by these materials are still not good enough for general acceptance in the marketplace. These polyphosphonates lack toughness at a molecular weight suitable for easy melt processing, and high temperature melt processing causes their molecular weight to decrease.

### SUMMARY OF THE INVENTION

In view of the above, there is a need for a method of producing linear polyphosphonates that have an advantageous combination of high Tg, toughness and processing characteristics. There is also a need for a method of synthesizing linear polyphosphonates without hydrolytically unstable or moisture absorbing end-groups.

It is, therefore, an object of the present invention to provide a method for producing linear polyphosphonates that possess good toughness and flame retardant properties at a low molecular weight by the transesterification route using specific molar ratios of a phosphonic acid diaryl ester, a bisphenol, and a catalyst.

It is another object of the present invention to formulate flame retardant, linear polyphosphonates that exhibit an advantageous combination of Tg, toughness and processing characteristics (i.e., low melt viscosity).

It is another object of the present invention to formulate polymer compositions comprising these linear polyphosphonates and commodity or engineering plastics.

It is yet another object of the present invention to produce articles of manufacture from these linear polyphosphonates or from polymer compositions comprising these linear polyphosphonates.

It is a further object of the present invention to improve the hydrolytic stability of these linear polyphosphonates or their polymer compositions with the application of a coating to the surfaces of the articles produced therefrom.

The present invention pertains to a method for producing linear polyphosphonates via a transesterification process, using a phosphonic acid diaryl ester, a bisphenol, and a catalyst at a specific molar ratio. This synthetic method yields flame retardant, linear polyphosphonates that exhibit an advantageous combination of high Tg, toughness and processing characteristics. This method involves placing 2 to 4.6 molar excess amount of a phosphonic acid diaryl ester (relative to the molar amount of bisphenol), a bisphenol, and at least about 0.001 mole of catalyst (per one mole of bisphenol) into a reaction vessel; heating the mixture in the vessel under vacuum to a temperature where phenol begins to distill from the vessel; and heating the reaction mixture until the evolution of phenol has stopped.

The present invention also pertains to polymer compositions produced from these linear polyphosphonates. A polymer composition comprises at least one linear polyphosphonate with at least one other polymer, which may be a commodity or engineering plastic, such as polycarbonate, polyacrylate, polyacrylonitrile, polyester, polyamide, polystyrene, polyurethane, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide polymer, polyanhydride, liquid crystalline polymer, cellulose polymer, or any combination thereof. The polymer composition may be produced via blending, mixing, or compounding the constituent polymers. The linear polyphosphonates impart flame retardant properties to the resulting polymer compositions. The present invention further relates to the application of coatings, particularly moisture barrier coatings, to the surface of articles produced from the linear polyphosphonates or the polymer compositions of the present invention for improved hydrolytic stability.

The linear polyphosphonates of the present invention can be used as coatings or they can be used to fabricate free-standing films, fibers, foams, molded articles, and fiber reinforced composites.

The above summary of the present invention is not intended to describe each illustrated embodiment or every implementation of the present invention. The detailed description, which follows, particularly exemplifies these embodiments.

### BRIEF DESCRIPTION OF THE DRAWINGS

The invention may be more completely understood in consideration of the following detailed description of various embodiments of the invention in connection with the accompanying drawing, in which:

FIG. 1 graphically illustrates the isothermal behavior of a linear polyphosphonate, according to an embodiment of the present invention (Example 2), in comparison to state-of-the-art branched polyphosphonates (Examples 3, 4 and 5).

While the invention is amenable to various modifications and alternative forms, specifics thereof have been shown by way of example in the drawing and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF EXEMPLARY EMBODIMENTS

The present invention pertains to a method for preparing flame retardant, linear polyphosphonates having an advantageous combination of properties (Tg, toughness and processability) via a transesterification process by reacting phosphonic acid diaryl ester and a bisphenol in the presence of a catalyst. The terms “flame retardant”, “flame resistant”, “fire resistant” or “fire resistance”, as used herein, mean that the polymer exhibits a limiting oxygen index of at least 27.

The reaction is conducted at a high temperature in the melt under vacuum. The reaction temperature and pressure are adjusted at several stages during the course of the reaction. The stoichiometric imbalance (i.e., molar ratio) of the phosphonic acid diaryl ester to the bisphenol and the concentration of the catalyst are important aspects of this invention. A stoichiometric imbalance ratio of from about 2 mole % to about 4.6 mole % excess of the phosphonic acid diaryl ester is preferred, with from about 2 mole % to about 3.5 mole % being more preferred, and with from about 2.1 mole % to about 2.8 mole % being most preferred. Precise control of the amount of catalyst is desirable in order to obtain polymer of sufficient molecular weight to exhibit good toughness and also to be essentially free of hydroxy or phenolate end-groups, which is important for both melt stability and hydrolytic stability. The term “good toughness”, as used herein, means that a specimen molded from the polymers of the present invention exhibit fracture energy that is much better than that of a specimen prepared from other polyphosphonates, as shown herein via examples 1 and 2 versus examples 3, 4 and 5.

The methods of the present invention allow for the use of phosphonic acid diaryl esters having purities less than 98%. The ability to use lower purity monomer is a major advantage because it mitigates the need for additional purification steps, which contributes to cost reduction. By following the methods of the present invention, linear polyphosphonates at a low molecular weight, essentially free of hydroxyl or phenolate end-groups, exhibiting good toughness and flame retardant properties are obtained. The term “low molecular weight”, as used herein, means that the polymer exhibits a relative viscosity of about 1.0 to about 1.20 when measured on a 0.5% weight/volume solution in methylene chloride solution at 23° C. These linear phosphonates possess outstanding flame resistance, an advantageous combination of high Tg (>130° C.), desired melt processing characteristics (such as low melt viscosity and excellent melt stability), and good toughness.

The catalyst is incorporated at least about 0.001 mole (per one mole of bisphenol), with the range of about 0.001 to about 0.005 moles per one mole of bisphenol being the preferred amount. The combination of the catalyst concentration and the excess concentration of the phosphonic acid diaryl ester is an important aspect of this invention.

The methods of the present invention for synthesizing linear polyphosphonates can be used with nearly any combination of a phosphonic acid diaryl ester, a bisphenol and a catalyst, preferably a basic catalyst. A phosphonic acid diaryl ester preferred for use herein is methyldiphenoxyphosphine oxide (chemical structure shown below).

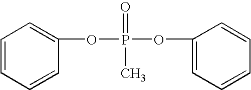

This synthetic method can be used with any bisphenol. Preferred bisphenols for use herein include 4,4′-dihydroxybiphenyl, 4,4′-dihydroxyphenyl sulfone, 2,2-bis(4-hydroxyphenyl) propane (bisphenol A), (these bisphenols are commercially available from, for example, Sigma-Aldrich Co., Milwaukee, Wis.; Biddle Sawyer Corp., New York, N.Y.; and Reichold Chemicals, Inc., Research Triangle Park, N.C., respectively), 4,4′-dihydroxyphenyl ether, 9,9-dihydroxy-phenylfluorene and 1,1-bis(4-hydroxyphenyl)-3,3-dimethyl-5-methyl cyclohexane (TMC) (chemical structure shown below). Copolymers prepared using two or more of any combination of bisphenols can also be prepared from this synthetic method.

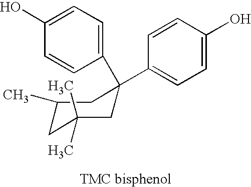

This method of synthesizing linear polyphosphonates is compatible with a variety of catalysts, such as alkaline metal phenolate derivatives, nitrogen containing phenolate derivatives and phosphorus containing phenolate derivatives. A preferred alkaline metal phenolate derivative is sodium phenolate. A more preferred alkaline metal phenolate derivative is sodium phenolate monohydrate. A preferred nitrogen-containing phenolate derivative is ammonium phenolate. (These various phenolates are commercially available from, for example, Sigma-Aldrich). A preferred phosphorus containing phenolate derivative is tetraphenyl phosphonium phenolate.

It is contemplated that linear polyphosphonates or the polymer compositions of the present invention may comprise other components, such as fillers, surfactants, organic binders, polymeric binders, crosslinking agents, coupling agents, anti-dripping agents, colorants, inks, dyes, or any combination thereof.

The linear polyphosphonates of the present invention can also be used to produce polymer compositions. The term “polymer composition”, as used herein, refers to a composition that comprises at least one linear polyphosphonate of the present invention and at least one other polymer. There term “other polymer”, as used herein, refers to any polymer other than the linear phosphonates of the present invention. These other polymers may be commodity or engineering plastics. Examples of these other polymers include polycarbonate, polyacrylate, polyacrylo-nitrile, polyester, polyamide, polystyrene (including high impact strength polystyrene), polyurethane, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide-polymer, polyanhydride, liquid crystalline polymer, cellulose polymer, or any combination thereof (commercially available from, for example, GE Plastics, Pittsfield, Mass.; Rohm & Haas Co., Philadelphia, Pa.; Bayer Corp.—Polymers, Akron, Ohio; Reichold DuPont, Wilmington, Del.; Huntsman LLC, West Deptford, N.J.; BASF Corp., Mount Olive, N.J.; Dow Chemical Co., Midland, Mich.; GE Plastics; DuPont; Bayer; Dupont; ExxonMobil Chemical Corp., Houston, Tex.; ExxonMobil; Mobay Chemical Corp., Kansas City, Kans.; Goodyear Chemical, Akron, Ohio; BASF Corp.; 3M Corp., St. Paul, Minn.; Solutia, Inc., St. Louis, Mo.; DuPont; and Eastman Chemical Co., Kingsport, Tenn., respectively). The polymer composition may be produced via blending, mixing, or compounding the constituent polymers. The linear polyphosphonate of the present invention impart flame retardant properties to the resulting polymer compositions.

In another embodiment of the present invention, the surfaces of articles fabricated from the linear polyphosphonates or the polymer compositions are coated to improve their hydrolytic stability. Coatings preferred for use herein are those that adhere well to the linear polyphosphonate and provide an effective barrier to moisture and/or high humidity. Examples of such preferred coating materials include polysilicones; polysiloxanes; polyoxysilsesquioxanes; fluoropolymers; liquid crystalline polymers; polymers containing metal, ceramic, metal oxide, or carbon particles, or any combination thereof; and sol-gel silicate-type; or any combination thereof (commercially available from, for example, Witco Chemical Corp., Greenwich, Conn.; Rhodia Silicones, Cranbury, N.J.; Gelest Inc., Morrisville, Pa.; Celanese AG, Dallas, Tex.; DuPont; and SDC Coatings, Inc., Anaheim, Calif., respectively). An example of a more preferred coating material is a polysiloxane that contains nanosilica and/or nanoalumina. The coatings can be applied by dip-coating, spraying, vacuum deposition, or other commonly used coating methods. A drying step may follow the application of the coating.

The linear polyphosphonates produced via the synthetic method of the present invention are self-extinguishing in that they immediately stop burning when removed from a flame. Any drops produced by melting these linear polyphosphonates in a flame instantly stop burning and do not propagate fire to any surrounding materials. Moreover, these linear polyphosphonates do not evolve any noticeable smoke when a flame is applied. Accordingly, these linear polyphosphonates can be used as additives in commodity or engineering plastics to significantly improve fire resistance without severely degrading their other properties, such as toughness or processing characteristics.

The linear polyphosphonates and the polymer compositions of the present invention can be used as coatings or they can be used to fabricate articles, such as free-standing films, fibers, foams, molded articles and fiber reinforced composites. These articles may be well-suited for applications requiring fire resistance.

The linear polyphosphonates of the present invention exhibit outstanding flame resistance and, a more advantageous combination of high Tg, toughness and processing characteristics, as compared to the state-of-the-art branched polyphosphonates of comparable molecular weight. These property improvements make the linear polyphosphonates of the present invention useful in applications requiring outstanding fire retardancy, high temperature performance, impact resistance, and the ability to be readily melt processed with negligible degradation. The method for synthesizing these linear polyphosphonates offers reduced complexity because it does not require a branching agent and requires less pure starting materials than the state-of-the-art methods. These features are important for reducing production costs.

The relationship and usefulness of solution viscosity as a measure of polymer molecular weight has been recognized since the 1930s. Solution viscosity is a measure of the size or extension in space of polymer molecules, it is empirically related to molecular weight. The simplicity of the measurement and the usefulness of the solution viscosity-molecular weight correlation are so great that viscosity measurement constitutes an extremely valuable tool for the molecular characterization of polymers. It is further recognized that lower molecular weight is indicative of lower melt viscosity, and low melt viscosity facilitates easy and cost-effective processing of polymers.

The limiting oxygen index (LOI) of a material is indicative of its ability to burn once ignited. This test for LOI is performed according to a procedure set forth by the American Society for Test Methods (ASTM). The test, ASTM D2863, provides quantitative information about a material's ability to burn or “ease of burn”. If a polymeric material has an LOI of at least 27, it will, generally, burn only under very high applied heat.

### EXAMPLES

Having generally described the invention, a more complete understanding thereof may be obtained by reference to the following examples that are provided for purposes of illustration only and do not limit the invention.

### Example 1

### Synthesis of Linear Polyphosphonate

A 250 mL, three neck round bottom flask equipped with a mechanical stirrer, a distillation column (10 cm) filled with hollow glass cylinders, a condenser, and a vacuum adapter with control valve was flushed with nitrogen for 0.5 hour. Methyldiphenoxyphosphine oxide (38.15 g)—because this compound is 97.22% pure as determined by high performance liquid chromatography (HPLC)—the precise amount of this compound is actually (37.09 g, 0.1495 moles), 4,4′-dihydroxybiphenyl (27.15 g, 0.1460 moles), and sodium phenolate monohydrate (0.022 g, 1.64×10⁻⁴ moles, 0.0011 mole per one mole of bisphenol) were placed into the flask and the flask was flushed with nitrogen again. (This is an excess of 2.4 mole percent of methyldiphenoxyphosphine oxide relative to the molar amount of bisphenol). The distillation column was wrapped with heating tape and heated. The reaction vessel was placed in an oil bath. The reaction mixture was heated and the vacuum was adjusted at various times during the reaction as indicated in Table I.

TABLE I
REACTION PARAMETERS

| Time after starting | Oil Bath Temp. | Vapor Temp. | Vacuum |
|---|---|---|---|
| (minutes) | (° C.) | (° C.) | (mm Hg) |
| 45 | 245 | 27 | 760 |
| 60 | 247 | 27 | 136 |
| 75 | 241 | 105 | 127 |
| 120 | 246 | 92 | 123 |
| 150 | 244 | 90 | 122 |
| 180 | 245 | 96 | 123 |
| 210 | 249 | 85 | 85 |
| 240 | 246 | 85 | 81 |
| 255 | 258 | 105 | 80 |
| 270 | 260 | 85 | 13 |
| 295 | 284 | 87 | 13 |
| 360 | 292 | 41 | 0.10 |
| 390 | 303 | 40 | 0.10 |
| 420 | 312 | 170 | 0.11 |
| 450 | 313 | 173 | 0.11 |
| 495 | 313 | 168 | 0.11 |
| 510 | 311 | 166 | 0.11 |
| 540 | 312 | 168 | 0.11 |
| 570 | 304 | 175 | 0.11 |
| 600 | 307 | 177 | 0.10 |
| Stopped | Stopped | Stopped | Stopped |

During the course of this reaction 28.5 g of distillate was collected. At the end of the reaction there was an increase in the viscosity of the polymer melt. Upon cooling, the viscous, light yellow melt began to solidify. After further cooling to room temperature, the flask was broken to isolate the solid. The solid polymer could not be cracked or broken with a hammer. It was so tough that it had to be removed from the stirring shaft with a saw. A 0.5% solution of the polymer in methylene chloride exhibited a relative viscosity of 1.17 at 23° C. A film was cast, in accordance to common casting methods, from a methylene chloride/polymer solution onto plate glass and subsequently thermally treated to remove the solvent. The film was transparent, tough, flexible, colorless, and exhibited a Tg of 135° C. It should be noted that the reaction temperature was held at slightly above 300° C. for more than about 3.5 hours. During this time, no decrease in the melt viscosity was observed.

A plaque was fabricated from this polymer via compression molding. This plaque was subjected to a burn test by placing the plaque directly in the flame of a propane torch. The plaque first softened and then melted due to its thermoplastic nature. Drops of molten plastic that dripped from the plaque immediately self-extinguished once they were out of the direct flame. In addition, the drops did not spread or propagate the fire to any surrounding materials. The plaque also stopped burning immediately upon removal of the flame. During this test, no smoke evolved from the plaque while it was in the flame or after the flame was removed. This test demonstrates the outstanding flame retardant characteristics of this linear polyphosphonate and, most importantly, its ability to self-extinguish. These properties are critical for applications requiring fire resistance.

### Example 2

### Synthesis of Linear Polyphosphonate

A 250 mL, three neck round bottom flask equipped with a mechanical stirrer, a distillation column (10 cm) filled with hollow glass cylinders, a condenser, and a vacuum adapter with control valve was flushed with nitrogen for 0.5 hour. Methyldiphenoxyphosphine oxide (38.87 g)—because this compound is 95.41% pure as determined by HPLC—the precise amount of this compound is actually (37.09 g, 0.1495 moles), 4,4′-dihydroxybiphenyl (27.15 g, 0.1460 moles) and sodium phenolate monohydrate (0.022 g, 1.64×10⁻⁴ moles, 0.0011 mole per one mole of bisphenol) were placed into the flask and the flask was flushed with nitrogen again. (This is an excess of 2.4 mole percent of methyldiphenoxyphosphine oxide relative to the molar amount of bisphenol). The distillation column was wrapped with heating tape and heated. The reaction vessel was placed in an oil bath. The reaction was conducted under the conditions described for Example 1.

At the end of the reaction, there was an increase in the viscosity of the polymer melt. Upon cooling, the viscous, light yellow melt began to solidify. After further cooling to room temperature, the flask was broken to isolate the solid. The solid polymer could not be cracked or broken with a hammer. It was so tough that it had to be removed from the stirring shaft with a saw. A 0.5% solution of the polymer in methylene chloride exhibited a relative viscosity of 1.11 at 23° C. A film was cast from a methylene chloride/polymer solution onto plate glass and subsequently thermally treated to remove the solvent. The resulting film was transparent, tough, flexible, colorless, and exhibited a Tg of 135° C. It should be noted that the reaction temperature was held at slightly above 300° C. for more than about 3.5 hours. During this time, no decrease in the melt viscosity was observed.

### Example 3

### State-of-the-Art Comparative Example (Branched Polyphosphonate)

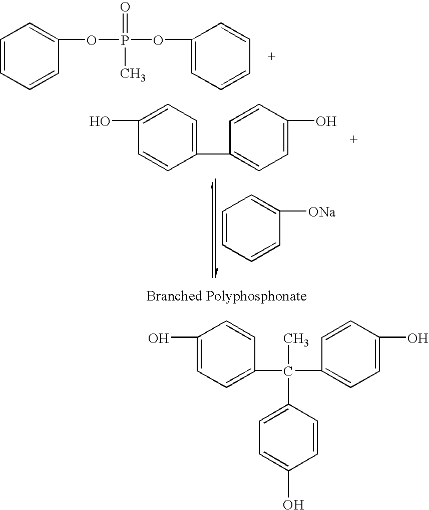

A branched polyphosphonate was prepared in accordance to U.S. Pat. Nos. 4,331,614 and 4,415,719 for the purpose of comparing with the linear polyphosphonates of the present invention. The molar excess of the bisphenol (4,4′-dihydroxydiphenyl, 29.76 g, 0.16 mole) to the phosphonic diester (38.19 g, 0.154 mole) was 3.8 mole %. The amount of sodium phenolate monohydrate used (0.002 g, 1.5×10⁻⁵ moles) was 9.4×10⁻⁵ moles relative to one mole of bisphenol, and (0.15 g, 5.0×10⁻⁴ moles) of the trihydroxy derivative (i.e., branching agent) was used. The polymer was isolated; it exhibited some toughness, but not as tough as the polymers described in Examples 1 and 2. A 0.5% solution of the polymer in methylene chloride exhibited a relative viscosity of 1.11 at 23° C. A film was cast from a methylene chloride/polymer solution onto plate glass and subsequently thermally treated to remove the solvent. The resulting film was brittle and slightly yellow in color and exhibited a Tg of 122° C.

### Example 4

### State-of-the-Art Comparative Example (Branched Polyphosphonate)

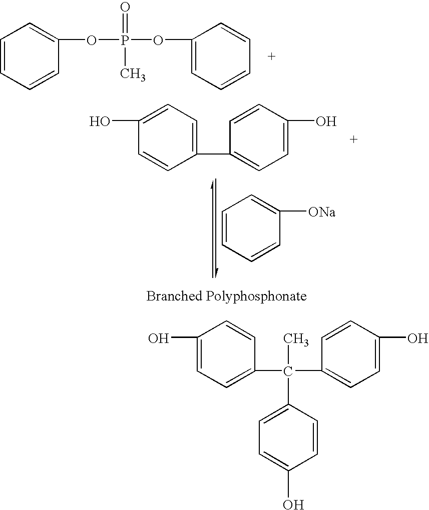

A branched polyphosphonate was prepared in accordance to U.S. Pat. Nos. 4,331,614 and 4,415,719 for the purpose of comparing with the linear polyphosphonates of the present invention. The molar excess of the phosphonic diester (40.01 g, 0.1613 mole) to the bisphenol (4,4′-dihydroxydiphenyl, 29.76 g, 0.16 mole) was 0.8 mole %. The amount of sodium phenolate monohydrate used (0.002 g, 1.5×10⁻⁵ moles) was 9.4×10⁻⁵ moles relative to one mole of bisphenol, and (0.15 g, 5.0×10⁻⁴ moles) of the trihydroxy derivative (i.e., branching agent) was used. The polymer was isolated; it exhibited some toughness, but not as tough as the polymers described in Examples 1 and 2. A 0.5% solution of the polymer in methylene chloride exhibited a relative viscosity of 1.15 at 23° C. A film was cast from a methylene chloride/polymer solution onto plate glass and subsequently thermally treated to remove the solvent. The resulting film was brittle and slightly yellow in color and exhibited a Tg of 115° C.

### Example 5

### State-of-the-Art Comparative Example (Branched Polyphosphonate)

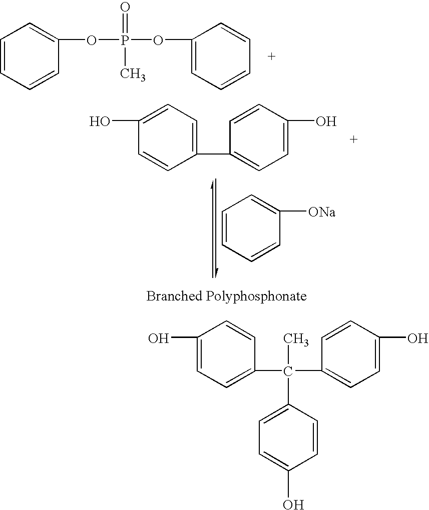

A branched polyphosphonate was prepared in accordance to U.S. Pat. Nos. 4,331,614 and 4,415,719 for the purpose of comparing with the linear polyphosphonates of the present invention. The molar excess of the phosphonic diester (41.9 g, 0.169 mole) to the bisphenol (4,4′-dihydroxydiphenyl, 29.76 g, 0.16 mole) was 5.6 mole %. The amount of sodium phenolate monohydrate used (0.004 g, 3.0×10⁻⁵ moles) was 1.9×10⁻⁴ moles relative to one mole of bisphenol, and (0.025 g, 8.16×10⁻⁵ moles) of the trihydroxy derivative (i.e., branching agent) was used. The polymer was isolated; it exhibited some toughness, but not as tough as the polymers described in Examples 1 and 2. A 0.5% solution of the polymer in methylene chloride exhibited a relative viscosity of 1.11 at 23° C. A film was cast from a methylene chloride/polymer solution onto plate glass and subsequently thermally treated to remove the solvent. The film was brittle and slightly yellow in color and exhibited a Tg of 118° C.

### Example 6

### Comparative Analysis of the Thermal Stability of Linear Polyphosphonate of Example 2 and Branched Polyphosphonates of Examples 3, 4 and 5

Samples of each polyphosphonate [Example 2 (linear polyphosphonate), Examples 3, 4 and 5 (branched polyphosphonates)] were dried in a vacuum oven at 100° C. for approximately 16 hours. They were subsequently placed in a thermogravimetric analyzer (TA Instruments, Model 2950), and heated to 310° C. under a nitrogen atmosphere and held for 50 minutes. The weight loss (in percent) was monitored as a function of time at this temperature. The linear polyphosphonate of Example 2 exhibited very little weight loss over the 50 minute exposure time (only about 0.5%). The comparative state-of-the-art examples 3, 4 and 5 (the branched polyphosphonates) having comparable relative viscosities (i.e., comparable molecular weight) exhibited a higher weight loss, losing more than 1.5% of their original weight. The weight loss curves for Examples 3 and 4 are indistinguishable and lie on top of each other.

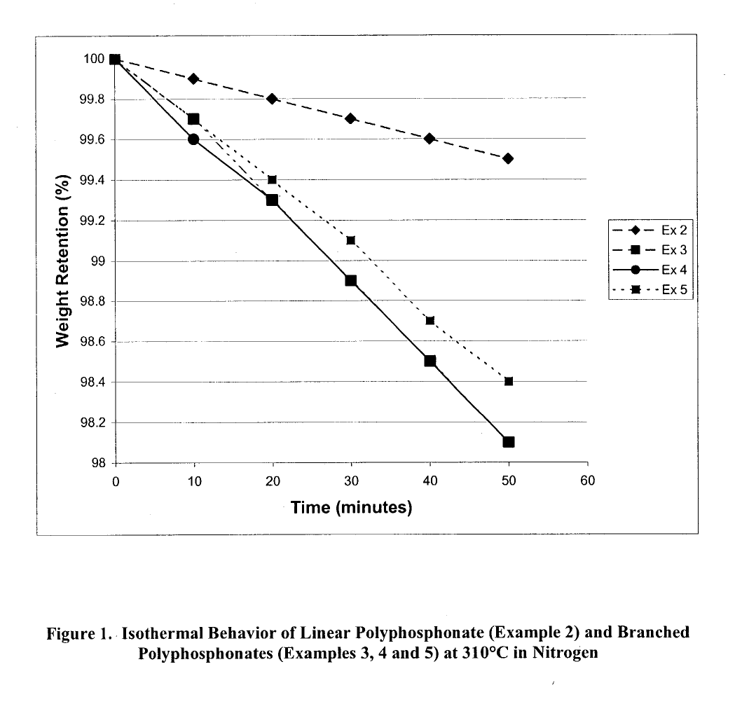

This experiment demonstrates that the linear polyphosphonates prepared in accordance to the method of the present invention exhibit improvements in thermal stability (which relates to melt stability and processing characteristics) and melt stability relative to state-of-the-art branched polyphosphonates. The weight loss curves of the linear polyphosphonate (Example 2), and the branched polyphosphonates (Examples 3, 4 and 5) at 310° C. in nitrogen are presented in FIG. 1.

### Example 7

### Molded Article Produced from Polyphosphonate of Example 1, Coated With Moisture Barrier

Two molded plaques, each approximately 150 microns thick, were prepared from the polyphosphonate composition of Example 1 by compression molding. One of the plaques was coated with a solution of a polysiloxane containing nanosilica and nanoalumina. The plaque was subsequently dried. The second plaque was not coated. The moldings were immersed in hot water (90° C.) for 3 hours, and changes in their physical appearance were monitored. After 3 hours, small fragments of material had become detached from the surface of the uncoated sample. This sample was somewhat degraded by the hot water treatment. In contrast, the coated plaque exhibited no visible changes after the 3-hour exposure, indicating that the surface coating had protected the polymer from degradation by hot water.

As noted above, the present invention is applicable to linear polyphosphonates, and methods and applications related thereto. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification.

We claim:

1. A method for producing linear polyphosphonates, comprising:
a) placing 2 to 4.6 molar excess amount of a phosphonic acid diaryl ester, a bisphenol, and at least about 0.001 mole of catalyst (per one mole of bisphenol) into a reaction vessel;
b) heating the mixture in the vessel under vacuum to a temperature where phenol begins to distill from the vessel; and
c) heating the reaction mixture until the evolution of phenol has stopped.

2. A method for producing linear polyphosphonates according to claim 1, wherein the amount of phosphonic acid diaryl ester is in excess (relative to the bisphenol) by an amount in the range of about 2.1 mole percent to about 2.8 mole percent.

3. A method for producing linear polyphosphonates according to claim 1, wherein the phosphonic acid diaryl ester is represented by the following chemical structure.

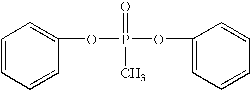

4. A method for producing linear polyphosphonates according to claim 1, wherein the amount of catalyst is in the range of about 0.001 moles to about 0.005 moles per one mole of bisphenol.

5. A method for producing linear polyphosphonates according to claim 1, wherein the catalyst is selected from the group consisting of sodium phenolate monohydrate, sodium phenolate dihydrate, sodium phenolate trihydrate, tetraphenylphosphonium phenolate, and any combination thereof.

6. A method for producing linear polyphosphonates according to claim 5, wherein the catalyst is sodium phenolate monohydrate.

7. A method for producing linear polyphosphonates according to claim 1, wherein the bisphenol is 4,4′-dihydroxybiphenyl, 2,2-bis(4-hydroxyphenyl)propane (bisphenol A), 1,1-bis(4-hydroxyphenyl)-3,3-dimethyl-5-methyl cyclohexane (TMC), or any combination thereof.

8. A linear polyphosphonate produced in accordance to the method of claim 1.

9. A linear polyphosphonate according to claim 8, wherein the linear polyphosphonate has a relative viscosity greater than 1.05 at 23° C.

10. A polymer composition, comprising:
a) at least one linear polyphosphonate produced in accordance to the method of claim 1; and
b) at least one other polymer.

11. A polymer composition according to claim 10, wherein the other polymer is a polycarbonate, polyacrylate, polyacrylonitrile, polyester, polyamide, polystyrene, polyurethane, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide polymer, polyanhydride, liquid crystalline polymer, polyether, polyphenylene oxide, cellulose polymer, or any combination thereof.

12. A polymer composition according to claim 11, wherein the other polymer consists essentially of polystyrene and polyphenylene oxide.

13. A polymer composition according to claim 11, wherein the other polymer consists essentially of polycarbonate and poly(acrylonitrile butadiene styrene).

14. A polymer composition according to claim 10, wherein the polymer composition exhibits a limiting oxygen index of at least 27.

15. A coating produced from the linear polyphosphonate of claim 8.

16. An article of manufacture produced from the linear polyphosphonate of claim 8.

17. An article of manufacture according to claim 16, wherein the article is a fiber, a film, a coated substrate, a molding, a foam, a fiber reinforced article, or any combination thereof.

18. An article of manufacture according to claim 16, wherein the article comprises a coating.

19. An article of manufacture according to claim 18, wherein the coating comprises polysilicone; polysiloxane; fluoropolymer; liquid crystalline polymer; polysilsesquioxane; polymers containing metal, ceramic, metal oxide, or carbon particles, or any combination thereof; and sol-gel silicate-type; or any combination thereof.

20. An article of manufacture according to claim 18, wherein the coating is a polysiloxane filled with nanosilica, nanoalumina, or a combination of the two fillers.

21. An article of manufacture produced from the polymer composition of claim 10.
